(19) United States
(12) Patent Application Publication
(10) Pub. No.: US 2017/0137153 A1
(43) Pub. Date: May 18, 2017

(54) Use of laser light to propel an object

(71) Applicant: J. A. Gonzalez Y Martin, Bonheiden (BE)

(72) Inventor: J. A. Gonzalez Y Martin, Bonheiden (BE)

(21) Appl. No.: 15/049,022

(22) Filed: Feb. 20, 2016

(51) Int. Cl. B64G 1/40

(52) U.S. Cl. CPC B64G 1/409

(57) ABSTRACT

Use of laser light (3) for the propulsion of an object, wherein a laser source (2) shines at the object with laser light (3) or wherein the object is provided with a laser source (2) that emits laser light (3).

The invention in question relates to the use of laser light to propel an object.

Historically, objects are propelled by using combustion engines which will burn fuel in order to generate momentum.

Traditional combustion engines like in cars and the like use this momentum to apply pressure to a piston and set it in motion in order for the energy and movement to be transferred to a crankshaft.

There are also jet engines, like in planes, satellites, rockets and spaceships, which are propelled by ejecting loads and loads of combustible gases.

Such combustion engines have the disadvantage they need fuel. There must always be a sufficient quantity of fuel present in order for the combustion engine to be able to work.

These are often fossil fuels, which produce noxious gases during combustion. Moreover, these fuels are non-renewable and reserves are not endless.

This causes mainly a problem for spaceships because they cannot be re-fuelled.

The invention in question aims to solve at least one of the above mentioned and also other disadvantages.

The invention will therefore deal with using laser light to propel an object. The laser light shall shine on the object from a laser source or the object shall be fitted with a laser source which will emit laser light.

The invention uses the laws of physics regarding action, reaction and the momentum conservation principle.

One advantage of using this invention is that the object can be set in motion with this principle.

The laser source shall emit electromagnetic radiation in the shape of laser light consisting of photons which do posses some momentum.

On the one hand, by shining a laser light on the object, it can experience the force exercised by the momentum of the photons in the light. Because of this force, we shall be able to propel the object or make it change direction which would mean a solution for our current problems of huge amounts of waste floating around in space which pose a real threat to spacecrafts such as satellites and the like which will get lost in collisions causing a huge loss of large investments which are needed to launch these crafts Into space and to keep them there.

On the other hand, by emitting photons with a certain momentum towards the object from the laser source, the object can be propelled with that same momentum in the opposite direction.

Another advantage is that there would be no fuel needed. Our laser source can produce laser light for example by using solar energy.

Another advantage is that a laser source emits a narrow coherent beam of laser light ensuring that the laser light can be aimed exactly at one particular object even when this object is located at a great distance of the laser source.

It would be preferable to alter the laser source's intensity.

This has the advantage that the momentum and therefore the speed with which the object is propelled can be adjusted.

Our laser source shall preferably emit laser light in the direction of magnetic material or a magnetic field.

According to the inventor, this will have as an advantage that because of the interaction between the laser light's electromagnetic field and the magnetic matter or the magnetic field, the effect can be magnified, enlarging the force with which the object is propelled.

Said magnetic matter or magnetic field shall preferably include a planet or celestial body's magnetosphere.

According to the inventor, one preferential characteristic of the invention should be a magnetically charged laser light, preferably with magnetic parts emitted by the laser source.

This would have the advantage that the laser light's magnetic field would be enlarged and the laser light's momentum would be increased.

In order to better display the invention's characteristics, we have described underneath as an example without any restrictive character some preferential models of the use of laser light for propelling an object in accordance with the invention, referring to attached drawings, in which:

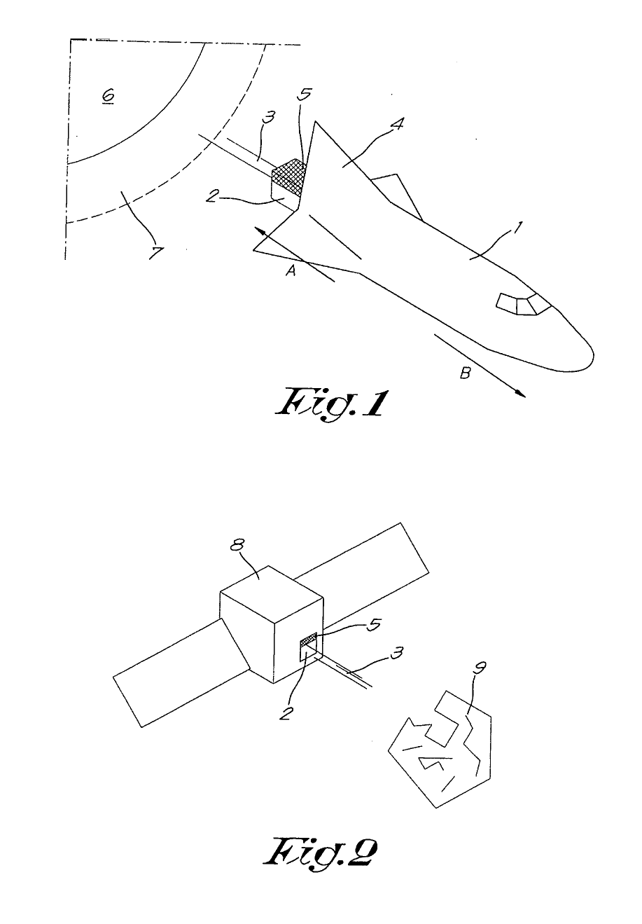

FIG. 1 is a diagram showing the use of laser light according to the invention for propelling a space craft;

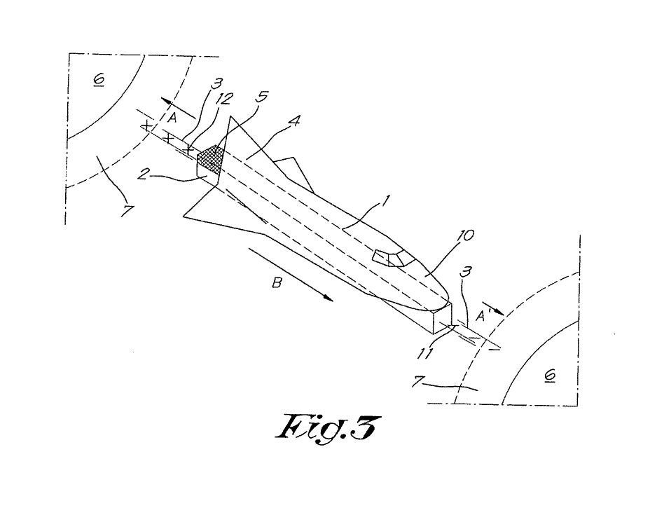

FIG. 2 is a diagram showing the use of laser light according to the invention for changing the course of objects in space;

FIG. 3 is a diagram showing another version of FIG. 1

The spacecraft shown in FIG. 1 is fitted with a laser source 2 which can emit laser light 3

The laser source 2 is located in this instance at the rear 4 of spacecraft 1 and the intensity and direction of emitted laser light 3 can be altered.

In such an instance, but that is not a necessity, the direction of emitted laser light 3 can be altered because laser source 2 has been adjustably fitted.

That way laser source 2 can emit laser light 3 in several directions

Laser source 2 has been fitted preferably in such a way it can emit laser light 3 in every or nearly every direction, meaning from top to bottom and up again in a 360 degrees circle.

Laser source 2 has been fitted with solar panels S in order to convert light into electric energy. Solar panels 5 can also be fitted to space craft 1.

FIG. 1 also shows a planet 6 with a magnetosphere 7.

The use of laser light 2 for propelling spacecraft 1 is very easy and goes as follows.

Laser source 2 shall emit laser light 3 in the direction of arrow A, causing spacecraft 1 to move in an opposite direction B

In FIG. 1 you will see spacecraft 1 near planet 6 and laser light 3 shall be emitted towards magnetosphere 7 of said planet 6.

The inventor is of the opinion that the force with which the object will be propelled shall be greater as a result. That then has the advantage that spacecraft 1 can distance itself quicker from planet 6.

Because the intensity and direction of laser light 3 can be altered, we can also change the speed and direction with which spacecraft 1 is propelled.

When solar panels 5 can catch the light of a star of the sun for example, they will be able to produce the electric energy used by laser source 2 to emit laser light 3.

It is quite possible for laser source 2 to be supplied with energy by means of nuclear power rather than solar panels 5.

That way a nuclear reactor or nuclear radiation source could be used.

That will bring the advantage that a lot of energy shall be available for laser source 2 so that it can emit laser light 3 with a lot of power, meaning laser light 3 will have high energy and intensity, which in its turn shall mean that spacecraft 1 can move a lot quicker.

FIG. 2 shows a different version from FIG. 1. In this case satellite 8 has been fitted with a laser source 2 at the front of satellite 8.

By emitting laser light 3 from laser source 2 in the direction of space waste 9, space waste 9 can be pushed out of the way of satellite 8 ensuring that satellite 8 does not get damaged or hindered or has to change its course in order to avoid space waste.

In order to make this possible, we can change the direction of laser light 3 so that laser light 3 can be emitted into different directions depending on where space waste 9 happens to be.

Laser light 3 emitted by laser source 2 is magnetically charged in this case with magnetic parts emitted by laser source 2.

Because the momentum of laser light 3 will be bigger, it will also be possible to propel space waste 9 of larger dimensions and/or weight or to propel it quicker.

In this example too it would be possible to use nuclear power instead of solar energy in order to produce energy for laser source 2.

It is quite clear that spacecraft 1 from FIG. 1 can also be fitted with a laser source 2 at its front with which space waste 9 can be pushed out of the way of spacecraft 1.

FIG. 3 shows a different model spacecraft 1 from FIG. 1

In this example laser source 2 runs through the whole of spacecraft 1 from back 4 to front 10 and laser source 2 can emit laser light 3 both backwards and forwards.

Laser light 3 is in this example magnetically charged and laser light 3 which is emitted forwards contains other magnetic parts 11, 12 than laser light 3 which is emitted backwards.

Laser light 3 is preferably emitted in the direction of magnetosphere 7 of two planets 6.

Inventor is convinced that parts 12 will generate a force A which pushes magnetosphere 7 away, to be precise that will be done by the parts 12 in laser light 3 emitted backwards, while at the same time parts 11 will generate a force A′ which will pull magnetosphere 7, to be precise that will be done by the parts 11 contained by laser light 3 that is emitted forwards.

That way spacecraft 1 will experience a net stronger propelling force B.

Spacecraft 1 will therefore be able to quickly move from one planet 6 to another planet 6.

It is clear that in all examples as described above instead of a spacecraft 1 or satellite 9, it is also possible to propel a rocket or any other type of spacecraft using laser light 3 and that other objects than space waste 9 can also be propelled by shining laser light 3 at them.

It is also clear that laser source 2 or laser sources 2 can also be located anywhere else on spacecraft 1 than at the front and/or the back.

The invention in question is absolutely not restricted to the examples and models described in these figures and the use of laser light in order to propel an object in accordance with the invention can be executed in different models without stepping out of the invention's framework.

1. The use of laser light (3) in order to propel an object, whereby laser source (2) aims a laser light (3) at the object or whereby the object has been fitted with a laser source (2) emitting laser light (3).

2. Use in accordance with conclusion 1, specifically characterised by the fact that laser source (2) can be adjusted.

3. Use in accordance with conclusion 1 or 2, specifically characterised by the fact that laser source (2) emits laser light (3) in the direction of magnetic matter or a magnetic field.

4. Use in accordance with conclusion 3, specifically characterised by the fact that magnetic matter or the magnetic field contains the magnetosphere (7) of a planet (6) or celestial body.

5. Use in accordance with one of the previous conclusions, specifically characterised by the fact that laser light (3) is magnetically charged.

6. Use in accordance with conclusion 5, specifically characterised by the fact that laser light (3) is magnetically charged with magnetic parts emitted by laser source (2).

7. Use in accordance with conclusion 6, specifically characterised by the fact that the laser source emits laser light (3) in two directions and laser light (3) contains a different kind of magnetic parts in each direction.

8. Use in accordance with one of the previous conclusions, specifically characterised by the fact that the object in question is a spacecraft like for example a spaceship (1), rocket, satellite (8) or something like that.

9. Use in accordance with one of the conclusions from 1 to 7, specifically characterised by the fact that our object is space waste (9).

10. Use in accordance with one of the previous conclusions, specifically characterised by the fact that laser source (2) is supplied with nuclear power energy.

11. Use in accordance with one of the previous conclusions, specifically characterised by the fact that the object has been fitted with a laser source (2) which can emit laser light (3) in all or nearly all directions.
